(19) United States
(12) Patent Application Publication
(10) Pub. No.: US 2007/0254098 A1
(43) Pub. Date: Nov. 1, 2007

(54) Apparatus for single-substrate processing with multiple chemicals and method of use

(75) Inventors: Alexander Sou-Kang Ko, Santa Clara, CA (US); Richard R. Endo, San Carlos, CA (US); Brian J. Brown, Palo Alto, CA (US); Kent Child, Los Banos, CA (US); Ralph Wadensweiller, Sunnyvale, CA (US)

Correspondence Address: APPLIED MATERIALS/BLAKELY, 1279 OAKMEAD PARKWAY, SUNNYVALE, CA, 94085-4040, US

(73) Assignee: APPLIED MATERIALS, INC.

(21) Appl. No.: 11/413,651

(22) Filed: Apr. 28, 2006

(51) Int. Cl. B05D 3/12; B05C 13/02

(52) U.S. Cl. 427/240; 118/52

(57) ABSTRACT

A single-substrate apparatus for wet chemical processing of one or multiple sides of a substrate is described. Embodiments of the present invention enable multiple chemicals to be applied to the substrate in succession and reclaimed substantially free of cross contamination between chemicals. In an embodiment of the present invention, a rotatable fluid diverter is positioned between a rotatable pedestal and a nonrotatable multi-level catch cup to funnel fluid shed from a substrate to a predetermined level of the catch cup. The rotatable fluid diverter is designed to expel fluid over a narrow spray angle and thereby enable the pitch of the levels in the catch cup to be reduced so that the chamber volume of the single-substrate apparatus is reduced. In another embodiment of the present invention, the rotatable pedestal is moveable so that the fluid shed from the substrate can be directed to away from the multi-level catch cup.

### BACKGROUND OF THE INVENTION

1. Field of the Invention

The present invention relates to the field of manufacturing equipment for fluid processing and more particularly to single-substrate wet chemical processing equipment for the electronics industry.

2. Discussion of Related Art

Substrate processing with fluids such as wet chemicals is typically done in either a batch-substrate mode or single-substrate mode. A batch-substrate apparatus processes multiple substrates in parallel through a sequence of chemical baths. A single-substrate apparatus processes an individual substrate through a sequence of chemical treatments. A single-substrate apparatus may further be operated in “single-pass” mode or “multi-pass” mode. In single-pass mode, the fluid dispensed onto the substrate is used only once and then discarded, while in multi-pass mode, the fluid chemical is reused on multiple substrates or administered to a single substrate multiple times. Because of higher chemical consumption, the single-pass mode is typically more expensive than the multi-pass mode. It is also known that batch-substrate processing tools have disadvantages relative to a single-substrate tool, but such disadvantages have been frequently outweighed by a lower relative cost per substrate for batch processing tools even when recycling or reusing chemical in single-substrate tools operating in multi-pass mode. The chamber size of a single substrate processing tool capable of multi-pass operation is one of the primary reasons for this higher relative cost.

FIG. 1 depicts an existing single-substrate processing apparatus 100 for applying multiple wet chemicals to the substrate in a multi-pass mode. As shown, chamber 105 contains a dispense arm 125 for dispensing process fluids upon substrate 110 as it is held to pedestal 120 by holders 115 and rotated about a central axis by shaft 127. As substrate 110 is rotated, fluid dispensed from dispense arm 125 is shed from substrate 110 or pedestal 120 because of centrifugal force. The fluid shed from substrate 110 is then collected by catch cup 140. Catch cup 140 may include, as shown in FIG. 1, multiple levels whereby each level provides a means to separate a first fluid collected from substrate 110 from a second fluid collected from substrate 110. Once collected the separate fluids may be reclaimed, recycled, and/or reused on subsequent process steps or substrates. During processing, the pedestal 120 is positioned relative to the levels of the catch cup 140 depending on the particular fluid dispensed upon the substrate 110. Because of the shape of substrate 110 or pedestal 120, particularly the edges and hardware used to affix the substrate 110 to the pedestal 120, the spray angle of fluid shed from substrate 100 or pedestal 120 is relatively large. The spray angle is defined as the angle from a plane through the substrate that is orthogonal to the axis of rotation encompassing substantially all trajectories of fluid shed from the substrate and/or pedestal 120. The height 145 of the catch cup levels must therefore also be relatively large typically between about 50 millimeters and 100 millimeters, to prevent the fluid spray intended for one catch cup level from entering an adjacent level causing one process chemical to contaminate another. However, the size of chamber 105 required to accommodate a multi-level catch cup having such a large height is a significant drawback relative to a batch processing tool, reducing the competitiveness of the design.

Thus, there remains a need to achieve a single-substrate processing apparatus capable of recycling multiple chemicals within a highly compact chamber.

### SUMMARY OF THE INVENTION

The present invention is a single-substrate wet chemical processing apparatus incorporating a bowl capable of expelling fluid over a reduced spray angle and the methods of use. The apparatus is designed to apply fluid to one or multiple sides of a substrate. Embodiments of the present invention enable multiple process chemical fluids to be applied to the substrate in succession and subsequently reclaimed substantially free of cross contamination between process chemical fluids.

In an embodiment of the present invention, a rotatable fluid diverter is positioned between a rotatable pedestal and a nonrotatable multi-level catch cup to funnel fluid shed from a substrate or the pedestal to a predetermined level of the catch cup. Incorporation of the fluid diverter enables the pitch of the levels in the catch cup to be reduced so that the chamber volume of the single-substrate apparatus is significantly reduced.

In a further embodiment, each level of the catch cup is coupled to a separate drain path and indexing the catch cup in a direction parallel to the axis of rotation of the fluid diverter aligns a particular level of the catch cup to the fluid diverter.

In another embodiment, the rotatable fluid diverter includes a curved inner surface to direct collected fluid out exit slots as the fluid diverter rotates.

In another embodiment, the exit slots and outer surface of the fluid diverter are designed to have overhanging edges to reduce the spray angle of the fluid expelled from the fluid diverter.

In a further embodiment of the present invention, the rotatable pedestal is moveable in a direction parallel to the axis of rotation so that the fluid shed from the substrate can be directed away from the multi-level catch cup and into a rinse cap. The rinse cap is coupled to a drain separate from the multi-level catch cup.

### BRIEF DESCRIPTION OF THE DRAWINGS

FIG. 1 is an illustration of a cross-sectional view of a prior art single-substrate processing apparatus.

FIG. 2 is an illustration of a cross-sectional view of a single-substrate processing apparatus in accordance with the present invention.

FIG. 3A is an illustration of a plan view of a fluid diverter in accordance with the present invention.

FIG. 3B is an illustration of a magnified cross-sectional view of a portion of a fluid diverter and catch cup in accordance with the present invention.

FIGS. 4a-4f are illustrations of cross-sectional view of a single-substrate processing apparatus operated in accordance with the present invention.

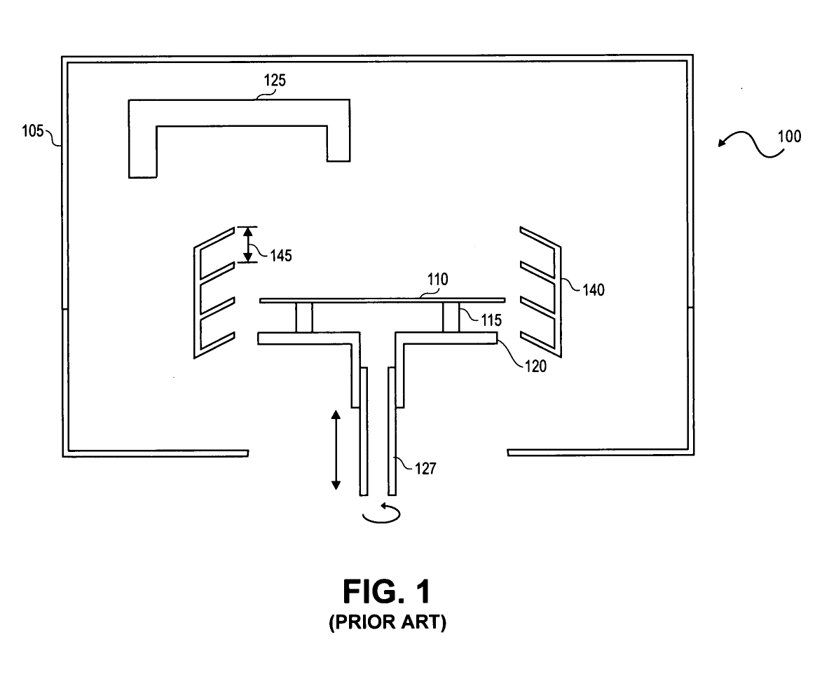

### DETAILED DESCRIPTION OF THE PRESENT INVENTION

In various embodiments, novel substrate processing equipment is described with reference to figures. However, various embodiments may be practiced without one or more of these specific details, or in combination with other known methods and materials. In the following description, numerous specific details are set forth, such as specific materials, dimensions and processes, etc. in order to provide a thorough understanding of the present invention. In other instances, well-known semiconductor processes and manufacturing techniques have not been described in particular detail in order to not unnecessarily obscure the present invention. Reference throughout this specification to “an embodiment” means that a particular feature, structure, material, or characteristic described in connection with the embodiment is included in at least one embodiment of the invention. Thus, the appearances of the phrase “in an embodiment” in various places throughout this specification are not necessarily referring to the same embodiment of the invention. Furthermore, the particular features, structures, materials, or characteristics may be combined in any suitable manner in one or more embodiments.

Certain embodiments of the present invention include an apparatus for processing single-substrates with wet chemicals. The substrate is an object which can be can be processed on a rotatable pedestal, for example, a disc-like object such as, but not limited to, a semiconductor wafer, compact disc, photographic masks used in the semiconductor industry, or LCD display panels. Semiconductor wafers are commonly of silicon but may further include compound semiconductors and wide bandgap materials such as GaN, SiC, and sapphire. Wet chemicals used in the apparatus are any of those commonly known to be advantageous in the processing of the particular substrate, such as, solvents, acids, oxidizers, polymer materials, resists, and water.

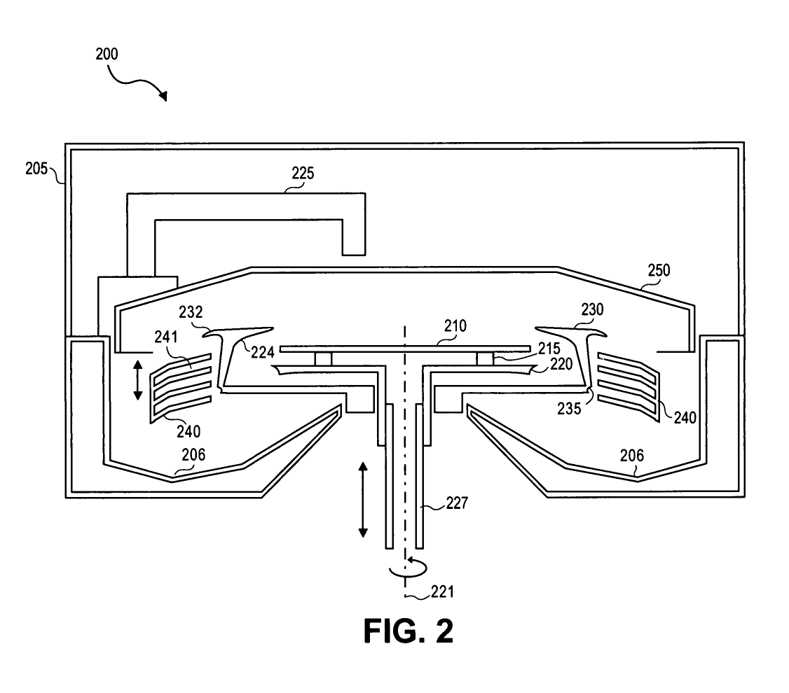

Apparatus 200 in FIG. 2 is an embodiment of the present invention. Apparatus 200 includes a compact chamber comprised of cover 205 and lower bowl 206. Lower bowl 206 is contoured to provide a drainage system for fluids. Substrate 210 is held to a pedestal 220 by mounts 215. Mounts 215 hold the substrate by mechanical or electrostatic means, such as vacuum, edge grip, or by inducing image charge in the substrate. Edge clamping is preferred in embodiments where fluids are applied to multiple sides of substrate 210. For example, embodiments of the present invention process either or both the front side and the backside of substrate 210 with fluids while the substrate is affixed to pedestal 220. The “backside” of substrate 210 refers to the surface adjacent to pedestal 220 in FIG. 2. In particular embodiments relating to semiconductor wafer substrates, the “backside” refers to the non-device side of the wafer.

During processing, fluid is applied to the frontside of substrate 210 by dispense arm 225. In an embodiment, fluid is additionally applied to the backside of substrate 210 through an opening in pedestal 220 supplied by a conduit passing through shaft 227. Pedestal 220 is rotatable about its central axis 221 and is driven by shaft 227. In particular embodiments, pedestal 220 is also movable in a direction parallel to the axis of rotation, as denoted by the solid arrows in FIG. 2. Thus, pedestal 220 may be vertically positioned relative to fluid diverter 230 to contain fluid spray. Fluid applied to either the front or backside of the substrate is shed from the substrate 210 or pedestal 220 edge, by centrifugal force. The fluid may be shed at a relatively large spray angle because of turbulence introduced by these edges. More specifically, fluid may collide with the leading edges of pedestal mounts 215, particularly when commonly known edge clamp designs are utilized. Thus, pedestal mounts 215 have been identified as a source of turbulent fluid flow characteristics causing large fluid spray angles.

Fluid diverter 230 is essentially a bowl surrounding pedestal 220 to collect the fluid sprayed from substrate 210 or pedestal 220 and funnel it to an exit point. The base of the fluid diverter surrounds the shaft 227. The cross-section of the fluid diverter sidewall is concave on the inside surface 224, or surface adjacent to the substrate 210. The top of the fluid diverter 230 forms an upper opening having a circumference which is larger than the circumference of the substrate to allow substrate 210 to be lowered to a position within the fluid diverter. The top further includes an overhang 232 extending beyond the outer wall of the fluid diverter. Fluid diverter 230 is rotatable about the central axis 221 of substrate 210 and may be rotated at various speeds. In a particular embodiment the speed is equal to the substrate rotational speed. In a further embodiment the fluid diverter 230 is mechanically affixed to pedestal 220. The rotation of fluid diverter 230 forcibly expels the fluid collected from the substrate out of the fluid diverter in a predominantly radial direction. The design of the exit slots 235, discussed in more detail below, enables the fluid shed from the fluid diverter 230 to be more controllable and at a reduced angle relative to the fluid shed from the substrate 210.

Surrounding fluid diverter 230, is a catch cup 240 which is annular in shape. The inner circumference of catch cup 240 is slightly larger than the outer circumference of fluid diverter 230. In the embodiment shown, catch cup 240 is comprised of multiple collection levels, wherein each collection level 241 is coupled to a separate drainage system (not shown). Depending on the application, the drainage system coupled to each level of the catch cup may allow the fluid to be recycled, reclaimed, reused, or simply discarded. Catch cup 240 mates with the overhang 232 to prevent fluid from entering catch cup 240 when the catch cup 240 is lifted, or indexed, to an uppermost position, as described in further detail below. Because the fluid diverter 230 sheds fluid in a controlled manner, the vertical height of each level of the catch cup may be greatly reduced, as discussed in more detail below.

The embodiment 200 further comprises a rinse cap 250, whereby rinse fluid is contained when pedestal 220 lifts substrate 210 above the confines of fluid diverter 230. The rinse cap may in turn be coupled to a drainage system (not shown) separate from those coupled to the catch cup 240.

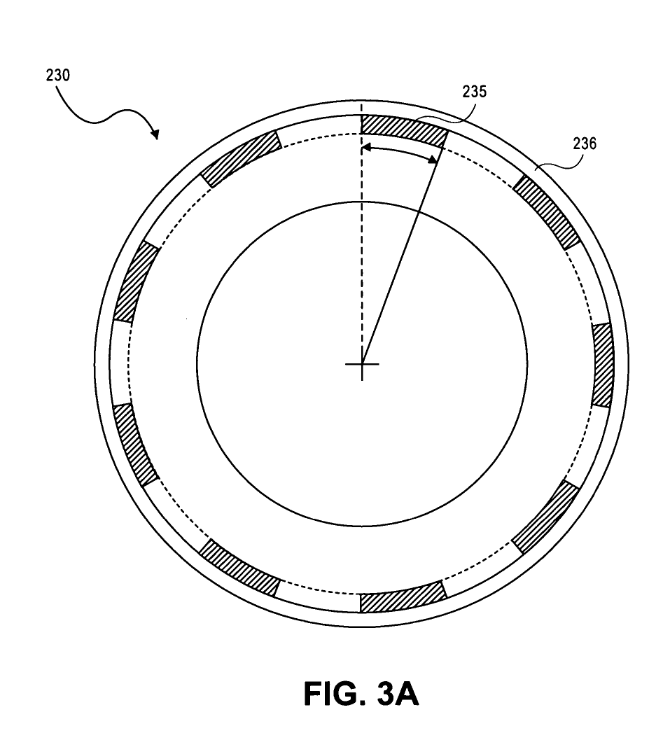

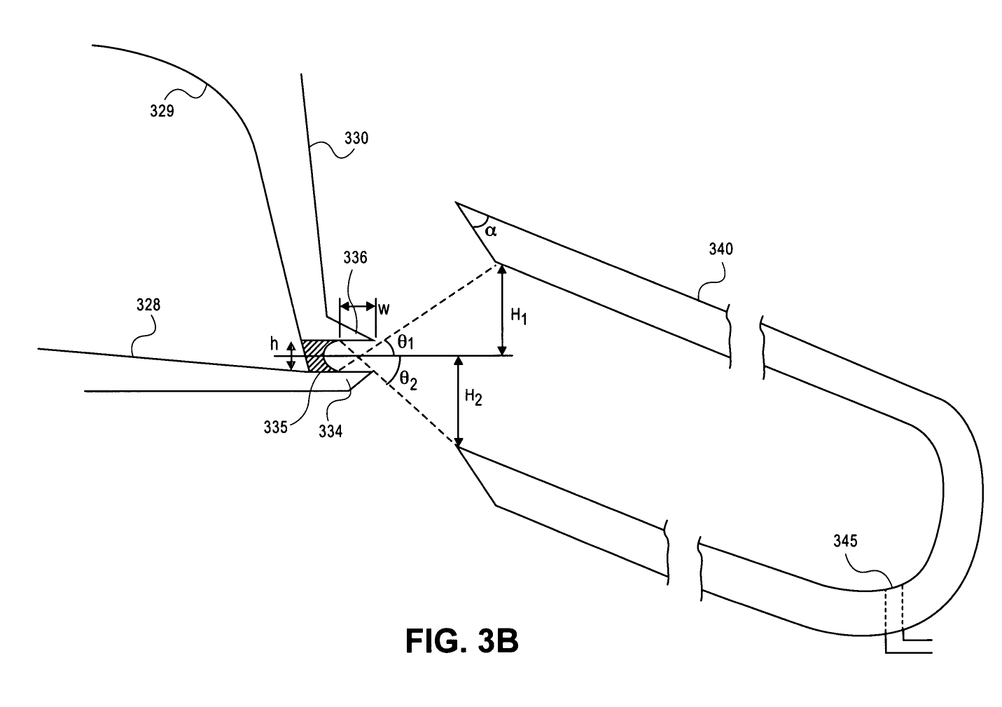

FIG. 3A shows a plan view of fluid diverter 230 in accordance with an embodiment of the present invention. Discrete exit slots 235 are formed along the outer circumference of fluid diverter 230 by slotting the sidewall of fluid diverter 230. Generally, it is advantageous to increase the cumulative angular length of the exit slots 235 to provide a larger exit path from which fluid may be expelled out of the fluid diverter 230. This can be done either through numerous exit slots 235, each of relatively short angular length, or by fewer exit slots, each having a relatively greater angular length. In a particular embodiment, as shown in FIG. 3A, nine exit slots, each of equal angular length, are equally spaced about the outer circumference of the fluid diverter. In a further embodiment, edge bead 236 circumscribes the fluid diverter extending radially outward beyond the walls of the exit slots, forming an overhang as further discussed below.

FIG. 3B shows an expanded cross-sectional view of an edge portion of the fluid diverter 330 proximate to the catch cup 340. As shown in this embodiment, the inner surface of the fluid diverter includes fluid diverter base 328 is sloped down with increasing radial distance to direct fluid radially outward toward the exit slots 335 as the fluid diverter is rotated. In an alternate embodiment, base 328 may slope up as radial distance increases to prevent fluid from dripping out of the exit slots 335 when the fluid diverter is stationary (not rotating). Such an upward sloping base 328 contains fluid until rotation of the diverter imparts sufficient radial momentum that the liquid is able to traverse the upward slope and reach the exit slots 335. Thus, embodiments with an upward sloping base 328 can ensure liquid exiting the fluid diverter 330 will have sufficient radial velocity to reach the catch cup 340 and not merely drip uncontrollably from the exit slots 335. The Fluid diverter top inner surface 329 forms slopes away from its inner circumference as the radial distance increases to direct fluid radially toward exit slots 335.

Exit slots 335 are designed to reduce the spray angle, θ₁+θ₂, of fluid exiting the fluid diverter. In this context, the spray angle is defined as the angle from a plane through the center of the exit slots 335 that is orthogonal to the axis of rotation encompassing substantially all trajectories of fluid shed from the exit slots 335. As previously discussed, a compact chamber design requires the fluid collected by a catch cup level to have a small spray angle. However, because the exit slots 335 are discrete, as the fluid diverter rotates, the trailing walls or edges of exit slots 335 collide with the fluid as do the leading edges of the pedestal mounts previously discussed. In one embodiment, to reduce to the spray angle of the fluid diverter 330 relative to the spray angle of the substrate and pedestal, fluid diverter 330 includes an overhanging member proximate to the exit slot 335.

In a particular embodiment, as shown in FIG. 3B, an overhanging member is provided by edge bead 336 on the outer surface of fluid diverter 330. Edge bead 336 is aligned with the top of the exit slots 335. In a further embodiment, a second, lower edge bead 334 is aligned with the bottom of the exit slots 335, such that edge beads 334 and 336 circumscribe the fluid diverter and exit slots 335 are formed between the two beads. The addition of the edge beads to the exit slots provides a continuous overhang and underhang. The fluid diverter spray angle may be tailored by changing the radial width, w, of the edge bead for a particular height, h, of the exit slots 335. As shown in FIG. 3B, the height, h, of exit slots 335 should be sufficiently large to allow fluids of moderately high viscosity to pass but minimized to reduce the required amount of bead overhang. In an embodiment, the height, h, of the exit slots is approximately 3 millimeters.

As bead 336 width, w, increases, the spray angle is reduced by the shadowing effect of the edge bead overhang. Fluid impacting the sidewall of exit slots 335 and spraying at angles greater than θ₁ (taken from the exit slots centerline orthogonal to the axis of rotation) contacts the underside of edge bead 336, where θ₁=tan⁻¹(h/w). Fluid contacting the edge bead then travels in a radial direction and angular direction until it separates from the trailing edge. Because edge bead 336 is continuous, there are no leading edges in the overhang from which fluid can be deflected to high spray angles and therefore fluid separates from the fluid diverter 330 with a very small angle. In a similar fashion, lower edge bead 334 limits the spray angle to θ₂ below the exit slot centerline. Thus, the spray angle can be effectively reduced by the overhanging and underhanging members proximate to the exit slots.

It is advantageous for the edge bead to be narrow in the direction parallel to the axis of rotation so that the overhang has a high aspect ratio. A high aspect ratio, or knife edge, acts to lower the aerodynamic turbulence induced by the overhang as the fluid diverter rotates. Reduced turbulence helps to further reduce the spray angle of the fluid exiting the fluid diverter. However, as the edge bead is made wider in the radial direction for purposes of increasing the overhang aspect ratio, the edge bead becomes more fragile, limiting the maximum practical bead width. In certain embodiments, the radial width of bead 336 is between about 3 millimeters and 6 millimeters. In a particular embodiment, the radial width of bead 336 is approximately 4 millimeters. In various other embodiments, the overhang incorporates other commonly known aerodynamic designs to reduce turbulence induced by the overhang.

As shown in FIG. 3B, the height, H₁+H₂, of a level of catch cup 340 depends the spray angle, θ₁+θ₂, as determined by the width, w, of the edge bead (overhang), and on the radial spacing between the outer surface of fluid diverter 330 and the inner circumference of the catch cup 340 surrounding the fluid diverter. As shown in FIG. 3B, the total height, H₁+H₂, must increase as this radial spacing between the fluid diverter 330 and catch cup 340 is increased for a given spray angle. Thus, the radial spacing should be no more than required for reliable mechanical clearance. In an embodiment the radial distance between the fluid diverter 330 and catch cup 340 is approximately 2 millimeters. In other embodiments, the radial spacing ranges from approximately 1 millimeter and approximately 3 millimeter.

In a further embodiment, the inner circumference of the catch cup 340 surrounding the fluid diverter may be chamfered to an angle α, as shown in FIG. 3B, decreasing the vertical faces of the partitions between adjacent collection levels of catch cup 340. There is a potential for condensate forming on such vertical surfaces to drip from a first catch cup collection level into a second catch cup collection level causing cross contamination between the collection levels. An edge chamfer helps prevent condensate from dripping off the partition and passed the collection level immediately below the partition. Any condensate forming on the chamfer surface will be consistently directed into the collection level immediately below the partition. In a particular embodiment, angle α is approximately 45 degrees.

Thus, in a particular embodiment, where the exit slot height, h, is approximately 3 millimeters, bead width, w, is approximately 4 millimeters, and the radial spacing between the fluid diverter 330 and the catch cup 340 is approximately 2 millimeters, the height, H₁+H₂, of a collection level of the catch cup is between approximately 11 millimeters and the vertical pitch is approximately 16 millimeters. In other embodiments the height, H₁+H₂, of the catch up level is between approximately 8 millimeters and 14 millimeters.

In an embodiment of the present invention, catch cup 240 is moveable in a direction parallel to the fluid diverter's axis of rotation so that, during operation, a particular level 241 may be selected and aligned to the fluid diverter exit slots 235. In this manner the fluid collected by fluid diverter 230 may be expelled to a particular catch cup level 241. As shown in FIG. 3B, the catch cup level is sloped between approximately 10 and 25 degrees from the horizontal to drain the collected fluid to the coupled drain system 345. Drain system 345 enables the fluid collected by the catch cup 340 to be recirculated, recycled, reused, or discarded independently from the other levels of catch cup 340. In this manner multiple process fluids can be utilized without cross contamination occurring in the catch cup.

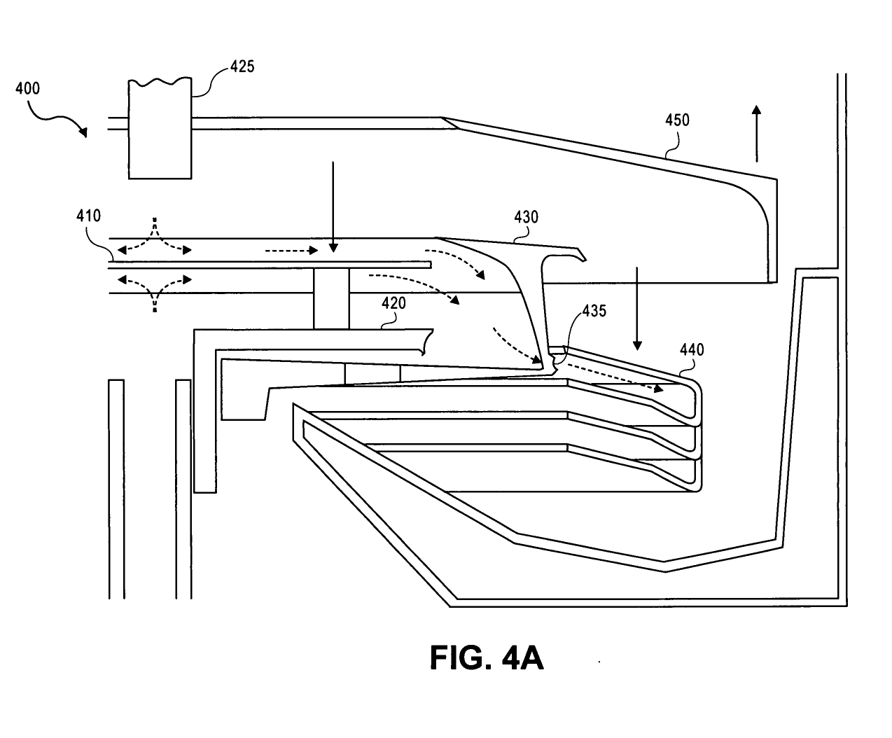

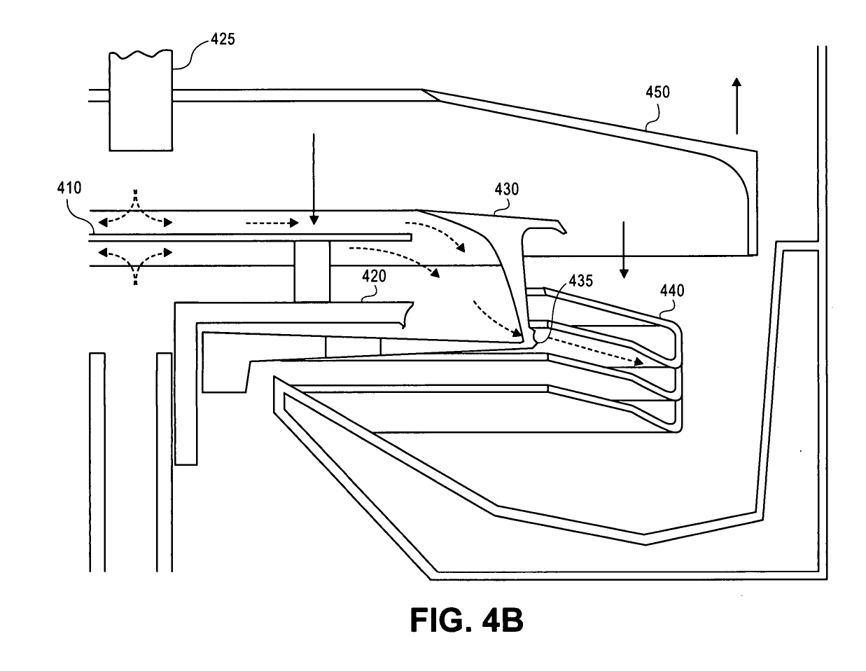

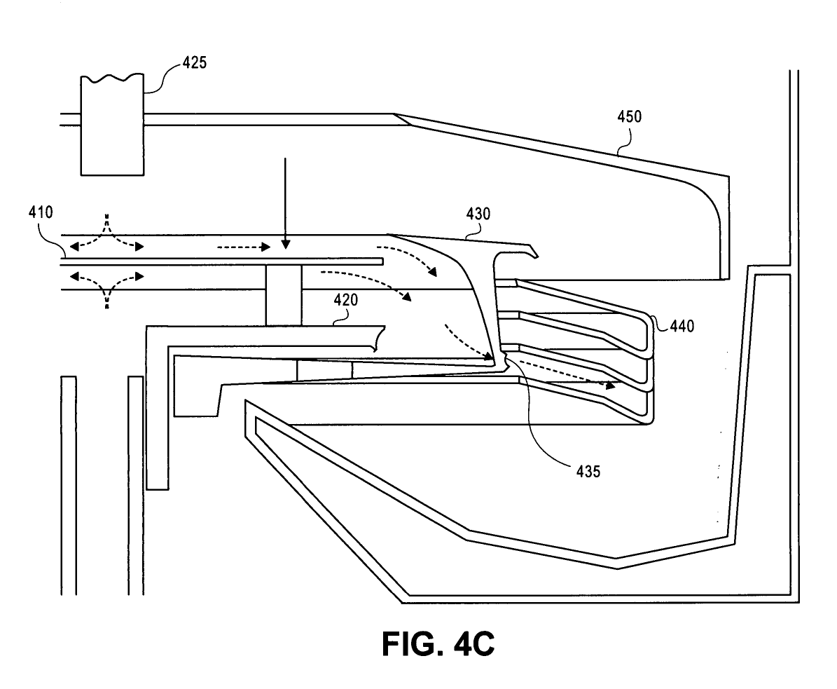

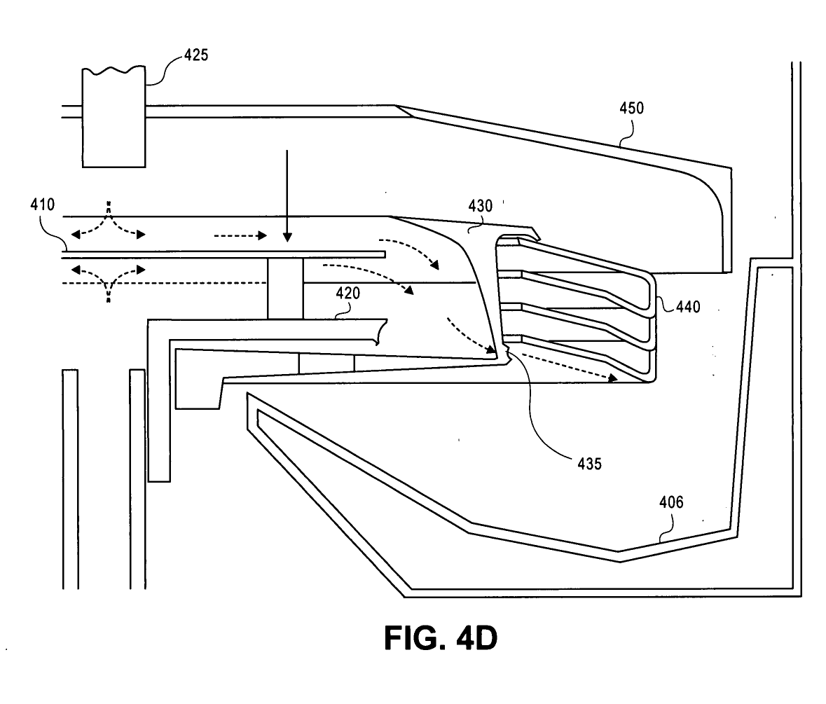

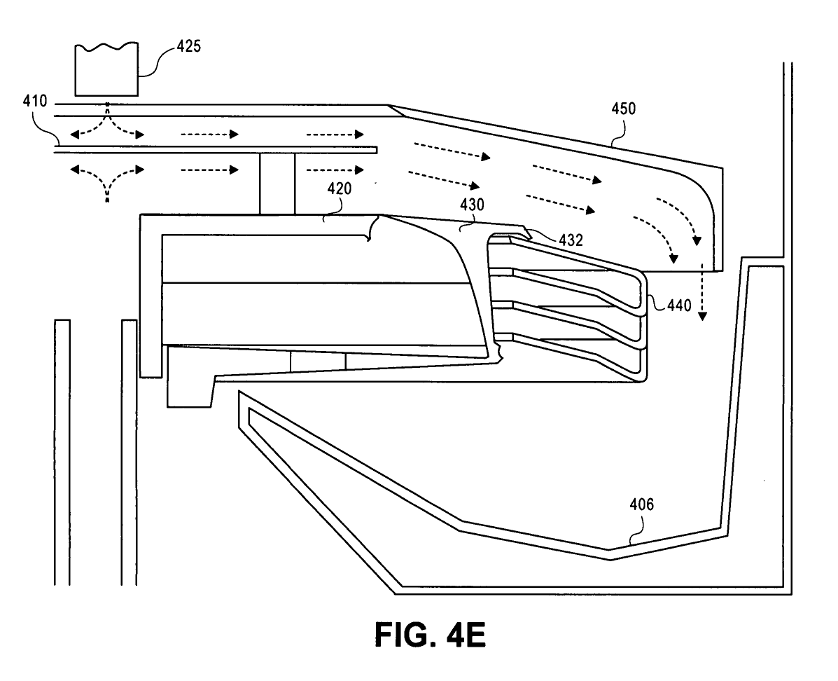

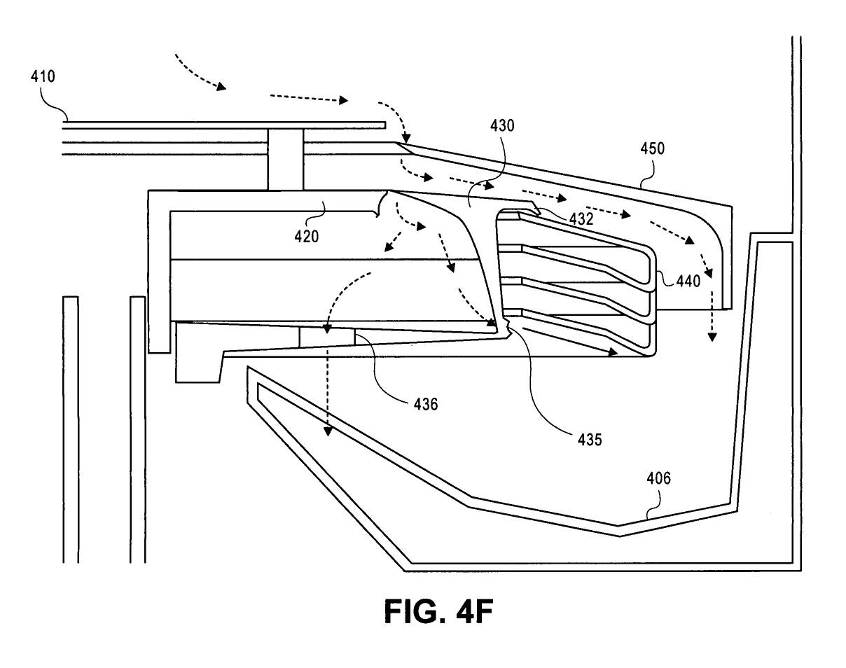

During operation, as shown in FIG. 4A, a substrate is loaded onto the pedestal 420 of the single-substrate apparatus 400. Pedestal 420 is lowered to a position such that the substrate 410 is contained within the fluid diverter 430. Catch cup 440 is indexed relative to the fluid diverter to align a first level of the catch cup to the fluid diverter exit slots 435 and rinse cap 450 is moved to an “up” position. A first fluid is dispensed by the nozzle 425 on the front side of substrate 410. Fluid flow is represented with dashed arrows in the figure. In a further embodiment, the first fluid may be further dispensed to the back side of substrate 410, as depicted in FIG. 4A. The fluid shed from the substrate 410 and/or pedestal 420 is collected by the fluid diverter 430, which funnels the collected fluid to the exit slots 435. Fluid expelled from exit slots 435 is then collected by the first level of the catch cup 440 aligned with the exit slots 435, as shown in FIG. 4A. In a particular embodiment the first level of the catch cup 440 is coupled to a drainage system configured to reclaim the first fluid. In another embodiment, pedestal 420 and fluid diverter may be spun at high speed to expel substantially all of the second fluid from the surface of substrate 410 and fluid diverter 430.

Next, in FIG. 4B, the catch cup 440 is indexed relative to the fluid diverter to align a second level of the catch cup to the fluid diverter exit slots 435 while rinse cap 450 remains in the up position. A second fluid is dispensed by the nozzle 425 on the front side of substrate 410. Fluid flow is represented with dashed arrows in the figure. In a further embodiment, the second fluid may be further dispensed to the back side of substrate 410, as depicted in FIG. 4B. The fluid shed from the substrate 410 and/or pedestal 420 is collected by the fluid diverter 430, which funnels the collected fluid to the exit slots 435. Fluid expelled from exit slots 435 is then collected by the second level of the catch cup 440 aligned with the exit slots 435, as shown in FIG. 4B. During this operation the second fluid mixes with the first fluid remaining on various surfaces of substrate 410, pedestal 420, and fluid diverter 430. Thus, in a particular embodiment the second level of the catch cup 440 is coupled to a drainage system configured to discard this cross-contaminated mixture of first and second fluids. In a further embodiment, the second fluid is a rinse fluid, such as water, to flush the substrate and apparatus of the first fluid. In another embodiment, pedestal 420 and fluid diverter may be spun at high speed to expel substantially all of the second fluid from the surface of substrate 410 and fluid diverter 430.

Next, as shown in FIG. 4C, the catch cup 440 is indexed relative to the fluid diverter to align a third level of the catch cup to the fluid diverter exit slots 435 while rinse cap 450 remains in the up position. A third fluid is dispensed by the nozzle 425 on the front side of substrate 410. Fluid flow is represented with dashed arrows in the figure. In a further embodiment, the third fluid may be further dispensed to the back side of substrate 410, as depicted in FIG. 4C. The fluid shed from the substrate 410 and/or pedestal 420 is collected by the fluid diverter 430, which funnels the collected fluid to the exit slots 435. Fluid expelled from exit slots 435 is then collected by the third level of the catch cup 440 aligned with the exit slots 435, as shown in FIG. 4C. In a particular embodiment the third level of the catch cup 440 is coupled to a drainage system configured to reclaim the third fluid. In a further embodiment, the third fluid is a chemical process fluid distinct from the first fluid. In another embodiment, pedestal 420 and fluid diverter may be spun at high speed to expel substantially all of the second fluid from the surface of substrate 410 and fluid diverter 430.

As shown in FIG. 4D, the catch cup 440 is indexed relative to the fluid diverter such that all catch cup levels are above the fluid diverter exit slots 435 while rinse cap 450 remains in the up position. A fourth fluid is dispensed by the nozzle 425 on the front side of substrate 410. Fluid flow is represented with dashed arrows in the figure. In a further embodiment, the fourth fluid may be further dispensed to the back side of substrate 410, as depicted in FIG. 4D. The fluid shed from the substrate 410 and/or pedestal 420 is collected by the fluid diverter 430, which funnels the collected fluid to the exit slots 435. Fluid expelled from exit slots 435 is then collected by the lower chamber bowl 406, as shown in FIG. 4D. In a particular embodiment the lower bowl 406 is coupled to a drainage system configured to discard the fourth fluid. In a further embodiment, the fourth fluid is a rinse fluid, such as water, to flush the substrate and apparatus of the third fluid. In another embodiment, pedestal 420 and fluid diverter may be spun at high speed to expel substantially all of the second fluid from the surface of substrate 410 and fluid diverter 430.

As shown in FIG. 4E, the catch cup 440 remains indexed relative to the fluid diverter so that all catch cup levels are above the fluid diverter exit slots 435. In this position, the fluid diverter top surface overhang 432 overlaps the top surface of the catch cup 440 to prevent fluid flowing over the top surface of the fluid diverter 430 from entering a level of the catch cup 430. Pedestal 420 is raised above the top surface of the fluid diverter 430 so that a fifth fluid dispensed by the nozzle 425 on the front side of substrate 410, as well as any fluid additionally dispensed to the back side of substrate 410, is shed into rinse cap 450 rather than fluid diverter 430. During this operation, rinse cap 450 remains in the up position and fluid is directed from the rinse cap into the lower bowl 406, as shown by the fluid flow dashed arrows in FIG. 4E. In a particular embodiment the lower bowl 406 is coupled to a drainage system configured to discard the fifth fluid. In a further embodiment, the fifth fluid is a rinse fluid, such as water, providing a final rinse of the substrate. In a further embodiment, the fifth fluid dispense is discontinued and the substrate spun dry.

As shown in FIG. 4F, with the pedestal 420 remaining in a position above fluid diverter 430, rinse cap 450 is lowered to a “down” position. The substrate may then be transferred dry from the apparatus chamber. In alternate embodiment, shown in FIG. 4F, a sixth fluid, such as water, is spray dispensed on the substrate as pedestal 420 and fluid diverter rotation is discontinued. The fluid shed from the substrate 410 and pedestal 420 flows along the paths depicted with dashed arrows, over the top surface of the fluid diverter 430 and catch cup 440, into the fluid diverter, passing through either exit slots 435 or base exit slots 436 into the lower bowl 406. In a particular embodiment the lower bowl 406 is coupled to a drainage system configured to discard the sixth fluid. In this embodiment, the substrate may then be transferred wet from the apparatus chamber to a desiccation unit.

Although the present invention has been described in language specific to structural features and/or methodological acts, it is to be understood that the invention defined in the appended claims is not necessarily limited to the specific features or acts described. The specific features and acts disclosed are to be understood as particularly graceful implementations of the claimed invention in an effort to illustrate rather than limit the present invention.

1. An apparatus comprising:
a rotatable pedestal to hold a substrate;
a means to dispense a fluid on the substrate; and
a rotatable fluid diverter, between the rotatable pedestal and an annular catch cup, to funnel the fluid shed from the substrate to the annular catch cup.

2. The apparatus of claim 1, wherein the fluid diverter sheds fluid over a spray angle that is smaller than a spray angle over which the fluid is shed from the substrate and pedestal.

3. The apparatus of claim 1, wherein the fluid diverter sheds the fluid at an angle less than approximately 40 degrees from a plane orthogonal to the axis of rotation of the fluid diverter.

4. The apparatus of claim 1, wherein the rotatable fluid diverter is circumscribed by a bead proximate to the exit slot to reduce the angle over which the fluid is shed by blocking the fluid having trajectories deviating substantially from a direction orthogonal to the axis of rotation.

5. The apparatus of claim 1, wherein the annular catch cup further comprises a plurality of collection levels to provide a selectable fluid drainage system.

6. The apparatus of claim 5, wherein the annular catch cup is moveable relative to the fluid diverter to align one of the plurality of collection levels to the fluid diverter exit slot.

7. The apparatus of claim 6, wherein the vertical height of each of the plurality of collection levels is less than approximately 13 millimeters.

8. The apparatus of claim 6, wherein the vertical pitch of the plurality of collection levels is less than approximately 18 millimeters.

9. The apparatus of claim 1, further comprising an annular rinse cap positioned above the fluid diverter and the annular catch cup, wherein the annular rinse cap is coupled to a drainage system separately configurable from the drainage systems coupled to the annular catch cup.

10. The apparatus of claim 9, wherein the inner diameter of the annular rinse cap is less than the outer diameter of the fluid diverter and the outer diameter of the annular rinse cap is greater than the outer diameter of the annular catch cup.

11. The apparatus of claim 10, wherein the annular rinse cup is movable relative to the fluid diverter.

12. The apparatus of claim 1, wherein the rotatable pedestal includes an edge grip to hold the substrate.

13. The apparatus of claim 1, wherein the rotatable pedestal is moveable in a direction parallel to the axis of rotation.

14. An apparatus comprising:
a rotatable pedestal to hold a substrate;
a dispense arm to apply a fluid to said substrate;
a rotatable fluid diverter surrounding the rotatable pedestal to funnel the fluid shed from the substrate to an exit slot formed in the fluid diverter;
an annular catch cup surrounding the fluid diverter to collect the fluid shed from the exit slot, wherein the annular catch cup is nonrotatable and includes a plurality of collection levels, each of which has a separately configurable drainage system.

15. The apparatus of claim 14, wherein each of the plurality of collection levels has an opening that less than approximately 13 millimeters high.

16. A method comprising:
dispensing a first fluid upon a substrate;
spinning the substrate to expel the first fluid from the substrate into a fluid diverter; and
spinning the fluid diverter to expel the first fluid from the fluid diverter into a first collection level of an annular catch cup to collect the first fluid in a first drainage system.

17. The method of 17, further comprising:
indexing the annular catch cup in a direction orthogonal from the axis of rotation of the fluid diverter to align a second collection level of the annular catch cup with the fluid diverter;
dispensing a second fluid upon the substrate;
spinning the substrate to expel the second fluid from the substrate into the fluid diverter; and
spinning the fluid diverter to expel the second fluid from the fluid diverter into the second collection level of the annular catch cup to collect the second fluid in a second drainage system, wherein the second drainage system is separate from the first drainage system.

18. The method of 17, wherein the first drainage system is plumbed to reclaim the first fluid and the second drainage system is plumbed to discard the second fluid.

19. The method of 17, further comprising:
positioning the substrate above the fluid diverter;
dispensing a third fluid upon the substrate;
spinning the substrate to expel the third fluid from the substrate into a rinse cap to collect the third fluid in a third drainage system, wherein the third drainage system is separate from the first and second drainage systems.

20. An apparatus comprising:
a rotatable bowl having an opening formed through a continuous wall to expel out of the bowl fluid, contained within the interior of the bowl, in a predominantly radial direction upon rotating the bowl, wherein the exterior surface of the bowl further includes an overhanging member having an angular length at least equal to that of the opening and positioned above the opening to reduce the angle over which the fluid is expelled from the bowl by blocking the fluid having trajectories deviating substantially from a direction orthogonal to the axis of rotation.

21. The apparatus of claim 20, wherein the overhanging member is a continuous bead circumscribing the outer surface of the bowl.

22. The apparatus of claim 20, wherein the radial width of the continuous bead is greater than the dimension of the opening along a direction parallel to the axis of rotation.
